(19) United States
(12) Patent Application Publication
(10) Pub. No.: US 2014/0040114 A1
(43) Pub. Date: Feb. 6, 2014

(54) Systems and Methods for Optimizing the Routing of Debit Transactions

(71) Applicant: FIRST DATA CORPORATION, Greenwood Village, CO (US)

(72) Inventors: Mark D. Baumgart, Larkspur, CO (US); Javier M. Alvarado, West Palm Beach, FL (US); George F. Gogol, North Olmsted, OH (US)

(73) Assignee: FIRST DATA CORPORATION, Greenwood Village, CO (US)

(21) Appl. No.: 13/670,075

(22) Filed: Nov. 6, 2012

Related U.S. Application Data
(60) Provisional application No. 61/679,390, filed on Aug. 3, 2012.

(51) Int. Cl. G06Q 20/26

(52) U.S. Cl. 705/39

(57) ABSTRACT

Embodiments of the disclosure provide for methods for obtaining, by a service provider system comprising one or more computers, information associated with a plurality of payment transactions processed via a plurality of transaction networks; generating, by the service provider system based at least in part upon the information, one or more graphical user interfaces associated with the distribution of payment transactions among the plurality of transaction networks; receiving, by the service provider system via the one or more graphical user interfaces, user input associated with the distribution of payment transactions; and generating, by the service provider system based upon the received user input, one of a recommendation or updated distribution information.

### CROSS-REFERENCE TO RELATED APPLICATIONS

This application claims priority to a provisional application referenced by U.S. Ser. No. 61/679,390, entitled “Systems and Methods for Optimizing the Routing of Debit Transactions,” filed on Aug. 3, 2012, the contents of which are incorporated herein by reference.

### TECHNICAL FIELD

Embodiments of the disclosure relate generally to payment transactions, and more specifically to the evaluation and/or optimization of debit transaction routing.

### BACKGROUND

In a conventional debit transaction with a merchant, a consumer typically swipes his or her card and elects to proceed with a debit transaction. Following the election of a debit transaction, the debit transaction is typically routed to a suitable PIN network based upon preferences of a card issuing entity, such as a financial institution that issued a debit card to the customer. However, in light of recent legislation, it may be possible to take preferences of other transaction parties, such as the merchant, into consideration during the routing of a debit transaction. Accordingly, there is an opportunity for new systems and methods for routing debit transactions based at least in part upon one or more merchant preferences and/or parameters. Additionally, there is an opportunity for providing merchants with information that facilitates routing decisions and/or optimizations.

### SUMMARY

Some or all of the above needs and/or problems may be addressed by certain embodiments of the disclosure. Disclosed embodiments may include systems and methods for optimizing routing of debit transactions. According to one embodiment, there is disclosed a method, including obtaining, by a service provider system comprising one or more computers, information associated with a plurality of payment transactions processed via a plurality of transaction networks; generating, by the service provider system based at least in part upon the information, one or more graphical user interfaces associated with the distribution of payment transactions among the plurality of transaction networks; receiving, by the service provider system via the one or more graphical user interfaces, user input associated with the distribution of payment transactions; and generating, by the service provider system based upon the received user input, one of a recommendation or updated distribution information.

According to another embodiment, there is disclosed a system which includes a service provider server, having one or more computers, wherein each computer is configured with a communication connection, wherein the service provider server is configured to: obtain information associated with a plurality of payment transactions processed via a plurality of transaction networks; generate one or more graphical user interfaces associated with the distribution of payment transactions among the plurality of transaction network, based at least in part on the information; receive, via the one or more graphical user interfaces, user input associated with the distribution of payment transactions; and generate based upon the received user input one of a recommended or updated distribution information.

According to further embodiments, there is disclosed one or more computer-readable media storing computer-executable instructions that, when executed by at least one processor, configure the at least one processor to perform operations including obtaining, by a service provider system comprising one or more computers, information associated with a plurality of payment transactions processed via a plurality of transaction networks; generating, by the service provider system based at least in part upon the information, one or more graphical user interfaces associated with the distribution of payment transactions among the plurality of transaction networks; receiving, by the service provider system via the one or more graphical user interfaces, user input associated with the distribution of payment transactions; and generating, by the service provider system based upon the received user input, one of a recommendation or updated distribution information.

Other embodiments, aspects, and features of the disclosure will become apparent to those skilled in the art from the following detailed description, the accompanying drawings, and the appended claims.

### BRIEF DESCRIPTION OF THE FIGURES

FIG. 1 illustrates a block diagram of an example system that may be utilized in accordance with various embodiments of the disclosure to facilitate the evaluation and optimization of transaction routing on behalf of merchants.

FIG. 2 illustrates a flow diagram of an example process for generating one or more presentations associated with the evaluation and/or optimization of transaction routing on behalf of a merchant, according to embodiments of the disclosure.

FIG. 3 illustrates a flow diagram of an example process for determining an optimized network order for routing transactions on behalf of a merchant, according to embodiments of the disclosure.

FIGS. 4-8 illustrate example graphical user interfaces that may be generated in accordance with various embodiments of the disclosure for presentation to merchants or other customers of a service provider.

### DETAILED DESCRIPTION

Various embodiments of the disclosure are directed to systems and methods for facilitating the evaluation of payment transactions submitted by merchants via any number of transaction networks and/or the optimization of transaction routing on behalf of the merchants. In one example embodiment, historical information associated with transactions submitted by a merchant may be collected from any number of suitable sources. For example, the merchant and/or any number of other external data sources may provide historical information. As another example, information may be collected and stored in real time as transactions are routed from merchant devices (e.g., merchant point of sale (“POS”) devices, merchant electronic commerce servers, etc.) to authorization and/or settlement systems (e.g., financial institutions, payment account issuers, etc.) via the transaction networks.

In certain embodiments, historical transaction information may be evaluated and/or processed in order to generate one or more presentations and/or reports, such as dashboard presentations, that may be provided to a merchant or other user. For example, a merchant (or user associated with the merchant) may access one or more presentations via a suitable web server. During the evaluation of the historical transaction information, transactions may be sorted and/or organized in accordance with any number of parameters, including but not limited to, transaction networks (e.g., a debit network or PIN network, etc.) utilized to route the transactions, various fees (e.g., network switch fees, network assessment fees, issuer interchange fees, issuer fraud recovery fees, issuer ad valorem fees, acquire transaction fees, etc.), transaction types (e.g., regulated or unregulated transaction, etc.), merchant point of sale locations, transaction amounts, transaction volumes, banking identification numbers (“BINs”), merchant classification codes (MCCs), regulated and unregulated classifications, etc. In this regard, a wide variety of statistical information may be presented via a dashboard presentation. For example, a merchant may be presented with information associated with percentages (and/or numbers) of transactions that are routed via various networks, sales volumes attributable to various networks, and/or fees incurred utilizing the various networks. Additionally, a merchant may provide a wide variety of input that is processed in order to re-sort and/or present data. In this regard, a merchant can review information associated with previously routed transactions.

Additionally, in certain embodiments, a merchant may alter a wide variety of variable data associated with the historical transaction information. For example, a merchant may alter the amounts of various fees incurred as the result of utilizing various transaction networks. In this regard, the merchant may model different transaction routing scenarios in order to determine desired routing arrangements. For example, a merchant may evaluate proposed fee arrangements offered by issuers, acquirers, and/or other entities associated with the transaction networks. As another example, a merchant may assess the value of existing routing and/or transaction processing arrangements. Indeed, a merchant may manipulate the historical transaction data for a wide variety of suitable business purposes.

As desired in certain embodiments, historical transaction information may also be evaluated in order to determine an optimal order for selecting transaction networks in order to route transactions. For example, historical transaction information may be provided to one or more models that determine an optimal transaction network order for a merchant. As desired, a wide variety of other information may also be provided to a model, such as information associated with special arrangements and/or deals for a merchant in association with various transaction networks (e.g., arrangement information received from merchants, arrangement information derived or determined from comparing historical transaction information with standard rate information and/or transaction information for other merchants, etc.), merchant preferences for network selections, etc. Based at least in part upon the modeling and/or analysis, an ordering of transaction networks (i.e., a hierarchy for selecting transaction networks for routing, etc.) may be optimized for the merchant along any number of parameters. For example, an ordering may be optimized in order to minimize fees paid by the merchant. Additionally, as desired, any number of routing tables may be generated in association with the optimized ordering, and the routing tables may be provided to the merchant and/or to merchant POS devices.

Embodiments of the disclosure now will be described more fully hereinafter with reference to the accompanying drawings, in which certain embodiments are shown. This invention may, however, be embodied in many different forms and should not be construed as limited to the embodiments set forth herein; rather, these embodiments are provided so that this disclosure will be thorough and complete, and will fully convey the scope of the invention to those skilled in the art. Like numbers refer to like elements throughout.

System Overview

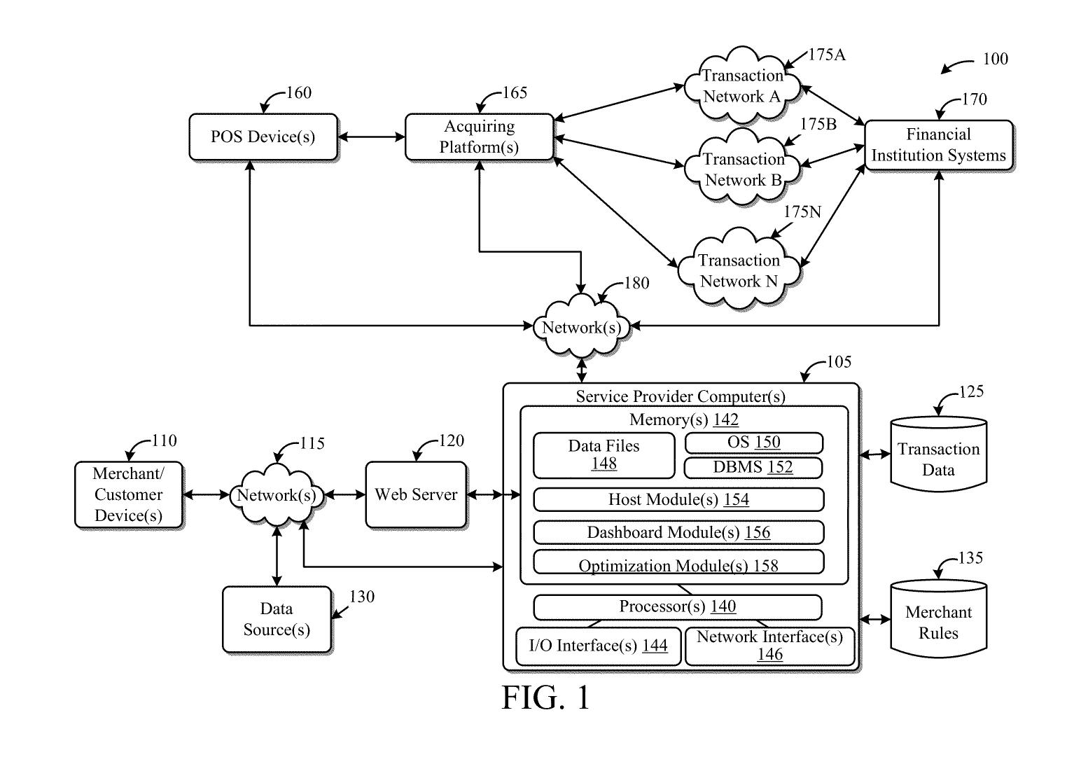

FIG. 1 illustrates a block diagram of an example system 100 that may be utilized in accordance with various embodiments of the disclosure to facilitate the evaluation and optimization of transaction routing on behalf of merchants. In certain embodiments, the system 100 may facilitate the modeling of transaction routing arrangements by any number of merchants, such as merchants that are customers of a service provider. In other embodiments, the system 100 may facilitate the optimization of a transaction network hierarchy. As shown in FIG. 1, the system 100 may include one or more service provider computers 105 and/or merchant or customer devices 110. In certain embodiments, communications between the service provider computers 105 and the merchant devices 110 may be facilitated via one or more suitable networks 115, such as the Internet, etc. For example, a merchant device 110 may access a web server 120 associated with the service provider computers 105 in order to review and/or manipulate information associated with transactions. Example merchant devices or customer devices can include, but are not limited to, a point of sale (POS) device, a personal computer, a laptop computer, a tablet computer, a netbook, a mobile phone, a smartphone, a handheld computer, or any other processor-based device operated by a merchant and/or customer.

With continued reference to FIG. 1, the service provider computer 105 may obtain and store information associated with historical transactions, such as historical debit transactions, routed on behalf of merchants. For example, historical transaction data may be stored in one or more historical transaction data databases 125. As desired, historical transaction information may be obtained from a wide variety of suitable sources, such as the merchant devices 110, any number of financial institution systems 170, and/or from any other suitable data sources 130 (e.g., various acquiring platforms, transaction processing service providers, etc.). Additionally, as desired, the service provider computer 105 may obtain, identify, and/or store any number of merchant parameters, preferences, and/or rules, such as transaction routing preferences, dashboard display generation parameters, and/or information associated with special arrangements between merchants and various transaction processors. As shown, at least a portion of the merchant information may be stored in one or more merchant rules databases 135.

With reference to FIG. 1, any number of service provider computers 105 may be provided. The service provider computers 105 may be associated with a suitable service provider that provides transaction network evaluation and/or optimization services to various merchants and/or other customers (e.g., acquiring platforms, financial institutions, etc.). A service provider computer 105 may include any number of processor-driven devices, including but not limited to, a server computer, a personal computer, one or more networked computing devices, an application-specific circuit, a minicomputer, a microcontroller, and/or any other processor-based device and/or combination of devices. A service provider computer 105 may utilize one or more processors 140 to execute computer-readable instructions that facilitate the general operation of the service provider computer 105 and/or the provision of transaction network evaluation and/or optimization services. As a result of executing these computer-readable instructions, a special purpose computer or particular machine may be formed that facilitates the provision of transaction network evaluation and/or optimization services.

In addition to having one or more processors 140, the service provider computer 105 may further include one or more memory devices 142 (generally referred to as memory 142), one or more input/output (“I/O”) interface(s) 144, and/or one or more network interface(s) 146. The memory 142 may be any computer-readable medium, coupled to the processor(s) 140, such as random access memory (“RAM”), read-only memory (“ROM”), and/or removable storage devices. The memory 142 may store a wide variety of data files 148, any number of databases such as the transaction data databases 125 and/or the merchant rules databases 135, and/or various program modules utilized by the service provider computer 105, such as an operating system (“OS”) 150, a database management system (“DBMS”) 152, one or more host modules 154, one or more dashboard modules 156, and/or one or more optimization modules 158.

Certain embodiments may be provided as a computer program product including a nontransitory machine-readable storage medium having stored thereon instructions (in compressed or uncompressed form) that may be used to program a computer (or other electronic device) to perform processes or methods described herein. For example, certain embodiments may be provided as a computer program product or group of products that may be executed by the service provider computers 105 or other suitable computing systems. The machine-readable storage medium may include, but is not limited to, hard drives, floppy diskettes, optical disks, CD-ROMs, DVDs, read-only memories (“ROMs”), random access memories (“RAMs”), EPROMs, EEPROMs, flash memory, magnetic or optical cards, solid-state memory devices, or other types of media/machine-readable medium suitable for storing electronic instructions. Further, embodiments may also be provided as a computer program product including a transitory machine-readable signal (in compressed or uncompressed form). Examples of machine-readable signals, whether modulated using a carrier or not include, but are not limited to, signals that a computer system or machine hosting or running a computer program can be configured to access, including signals downloaded through the Internet or other networks. For example, distribution of software may be Internet download.

With reference to the contents of the memory 142, the data files 148 may include any suitable data that facilitates the operation of the service provider computer 105 and/or interaction of the service provider computer 105 with one or more other components of the system 100. For example, the data files 148 may include information associated with communicating with one or more merchant devices 110, historical information associated with debit transactions, merchant rules and/or parameters, transaction network fee information, information associated with fee arrangements between merchants and transaction processing systems and/or networks, information associated with transaction evaluation models, information associated with transaction network optimization, etc. The transaction data databases 125, which may include any number of internal and/or external databases, may include a wide variety of information associated with historical transactions, such as transaction date information, transaction amount information, information associated with transaction networks utilized to route the transactions, transaction routing fee information, merchant origination or POS information (e.g., store numbers, POS terminal identifier, geographical information, etc.), etc. The merchant rules databases 135, which may include any number of internal and/or external databases, may include a wide variety of merchant rules, parameters, and/or preferences associated with the sorting of historical transaction information, the evaluation of historical transaction information, the generation of one or more presentations and/or reports associated with historical transaction information, and/or the optimization of a transaction network order or hierarchy.

The OS 150 may be suitable module that facilitates the general operation of the service provider computer 105, as well as the execution of other program modules. The DBMS may include any number of suitable modules and/or applications that facilitate the management of data stored in the data files 148 and/or the various databases 125, 135. The host modules 154 may include any number of suitable modules and/or applications, such as a Web server module, that facilitate the establishment and/or management of a communications session between the service provider computer 105 and a merchant device 110. In certain embodiments, a host module 154 may facilitate establishment of a communications session hosted by the service provider computer 105. In other embodiments, the host module 154 may be incorporated into and/or associated with a Web server 120 that is accessible by the merchant devices 110.

The dashboard modules 156 may include one or more suitable software modules and/or applications configured to generate any number of presentations and/or reports associated with historical transactions. Additionally, the dashboard modules 156 may be configured to receive a wide variety of user input from a merchant device 110 and to process the received user input to modify presentations and/or to provide predictions and/or estimations associated with transaction routing. In operation, the dashboard modules 156 may obtain historical information associated with transactions submitted by a merchant may be collected from any number of suitable sources. For example, historical transaction information may be accessed from the transaction data databases 125, received from one or more merchant devices 110 (e.g., received via batch files and/or other asynchronous communications, etc.), received from one or more of the data sources 130, and/or received from other components of the system 100.

The dashboard modules 156 may evaluate the historical transaction information and sort or organize transactions in accordance with any number of parameters, including but not limited to, transaction networks (e.g., a debit network or PIN network, etc.) utilized to route the transactions, various fees (e.g., network switch fees, network assessment fees, issuer interchange fees, issuer fraud recovery fees, issuer ad valorem fees, acquire transaction fees, etc.), transaction types (e.g., regulated or unregulated transaction, etc.), merchant point of sale locations, transaction amounts, transaction volumes, banking identification numbers (“BINs”), etc. In this regard, a wide variety of statistical information and/or representative information associated with transaction distribution may be included presented via one or more dashboard presentation generated by the dashboard modules 156 for communication to a merchant device 110. For example, a merchant may be presented with information associated with percentages (and/or numbers) of transactions that are routed via various networks, sales volumes attributable to various networks, and/or fees incurred utilizing the various networks.

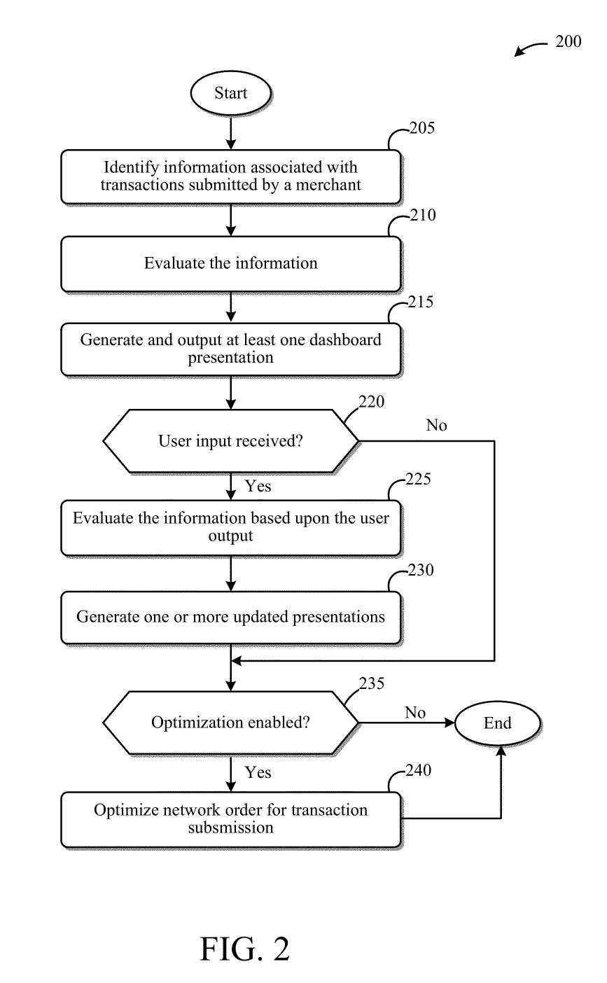

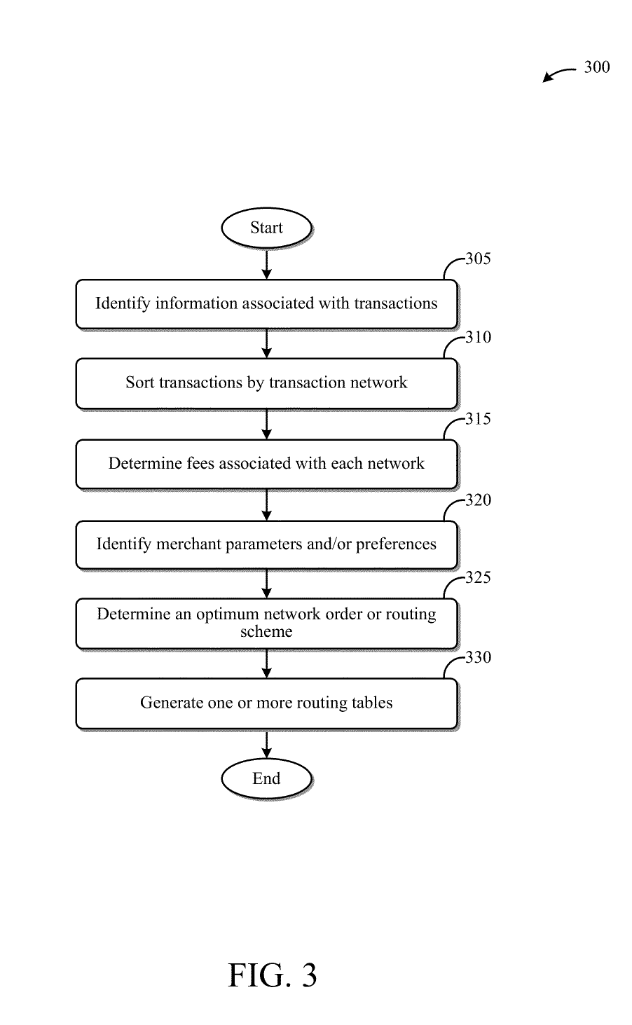

Additionally, a merchant may provide a wide variety of input that is processed by the dashboard modules 156 in order to re-sort and/or modify presented data. In this regard, a merchant can review information associated with previously routed transactions. Additionally, user input may be processed to alter a wide variety of variable data associated with the historical transaction information. For example, a merchant may alter the amounts of various fees incurred as the result of utilizing various transaction networks. In this regard, the merchant may model different transaction routing scenarios in order to determine desired routing arrangements. For example, a merchant may evaluate proposed fee arrangements offered by issuers, acquirers, and/or other entities associated with the transaction networks. As another example, a merchant may assess the value of existing routing and/or transaction processing arrangements. Indeed, a merchant may manipulate the historical transaction data for a wide variety of suitable business purposes. A few examples of the operations of the dashboard modules 156 are described in greater detail below with reference to FIGS. 2 and 3.

The optimization modules 158 may include one or more suitable software modules and/or applications configured to determine an suitable or optimal order for selecting transaction networks in order to route transactions. In operation, the optimization modules 158 may invoke one or more models and/or utilize other suitable evaluation techniques to process historical transaction information associated with a merchant. As desired, a wide variety of other information may be evaluated by the optimization modules 158 and/or provided to the model(s), such as information associated with special arrangements and/or deals for a merchant in association with various transaction networks (e.g., arrangement information received from merchants, arrangement information derived or determined from comparing historical transaction information with standard rate information and/or transaction information for other merchants, etc.), merchant preferences for network selections, etc. Based at least in part upon the modeling and/or analysis, an ordering of transaction networks (i.e., a hierarchy for selecting transaction networks for routing, etc.) may be optimized for the merchant along any number of parameters. For example, an ordering may be optimized in order to minimize fees paid by the merchant. Additionally, as desired, any number of routing tables may be generated in association with the optimized ordering, and the routing tables may be provided to the merchant and/or to merchant POS devices. A few examples of the operations that may be performed by the optimization modules 158 are described in greater detail below with reference to FIGS. 2 and 3.

The one or more I/O interfaces 144 may facilitate communication between the service provider computer 105 and one or more input/output devices; for example, one or more user interface devices, such as a display, a keypad, a keyboard, a touch screen display, a microphone, a speaker, a mouse, etc., that facilitate user interaction with the service provider computer 105. The one or more network and/or communication interfaces 146 may facilitate connection of the service provider computer 105 to any number of suitable networks, for example, the network(s) 115, 180 illustrated in FIG. 1. In this regard, the service provider computer 105 may receive and/or communicate information to other components of the system 100.

With continued reference to FIG. 1, any number of merchant and/or customer devices 110 may be included in the system 100. A merchant device 110 may be configured to access one or more services hosted by the service provider computers 105 in order to review and/or manipulate historical transaction information. In this regard, a user of the merchant device 110 may evaluate parameters associated with the routing of payment transactions and/or model various alterations to routing determinations. Additionally, in certain embodiments, a merchant device 110 may be configured to provide historical transaction information (e.g., batch files of historical transaction information, etc.) and/or various merchant preferences to the service provider computers 105 for processing and evaluation. In certain embodiments, a merchant device 110 may include similar components as those discussed above for the service provider computer 105. For example, a merchant device 110 may include any number of processors, memories, I/O interfaces, and/or network/communication interfaces.

Additionally, any number of data sources 130 may be included in the system 100. A data source 130 may be configured to provide historical transaction information (e.g., batch files of historical transaction information, real-time transaction processing information, etc.) to the service provider computers 105 for processing and evaluation. Historical transaction information may be pushed to the service provider computers 105 at predetermined periods of time (e.g., hourly, daily, etc.) and/or based upon the identification of predetermined events. Additionally or alternatively, historical transaction information may be communicated to the service provider computers 105 in response to one or more requests for the information. A data source 130 may be associated with a wide variety of different entities as desired in various embodiments, such as a merchant, an acquirer platform, a financial institution or payment account issuer, or a service provider that facilitates transaction routing and/or that processes routed transactions. In certain embodiments, a data source 130 may include similar components as those discussed above for the service provider computer 105. For example, a data source 130 may include any number of processors, memories, I/O interfaces, and/or network/communication interfaces.

A wide variety of suitable networks 125, 180 (which may be the same or separate networks) and/or communication channels may be utilized to facilitate communications between the merchant devices 110, the service provider computers 105, the data sources 130, and/or other components of the system 100. These networks may include, but are not limited to, one or more telecommunication networks, cellular networks, wide area networks (e.g., the Internet), and/or local area networks. Various methodologies as described herein may be practiced in the context of distributed computing environments. It will also be appreciated that the various networks may include a plurality of networks, each with devices such as gateways and routers for providing connectivity between or among networks. Additionally, instead of, or in addition to, a network, dedicated communication links may be used to connect various devices in accordance with an example embodiment.

In certain embodiments, the service provider computers 105 may be configured to capture transaction information as transactions are routed from merchant POS devices 160 to various authorization and/or settlement systems, such as various financial institution and/or account issuer systems 170. For example, a merchant POS device 160 (or another merchant system such as an eCommerce server) may output transaction-related information (e.g., a payment transaction request, etc.) associated with a debit transaction for delivery to a financial institution system 170. In certain embodiments, the transaction-related information may be communicated to an acquiring platform 165 associated with the merchant. In certain embodiments, the POS device 160, the acquiring platform 165, and/or the service provider computer 105 may identify and/or select a suitable transaction network 175A-N (e.g., a PIN network) for routing the transaction-related information to an appropriate financial institution system 170. For example, various routing preferences may be evaluated in order to select an appropriate transaction network for routing the transaction. In one example embodiment, transaction networks available for routing the transaction may be identified. Merchant preferences (e.g., a desired hierarchy for selecting a transaction network and/or threshold parameters associated with routing transactions, such as volume, fee, and/or transaction amount thresholds, etc.) and/or transaction-related information (e.g., an identifier of a POS device 160, a transaction amount, etc.) may be evaluated in order to select a transaction network for routing. The transaction-related information may then be communicated to a financial institution system 170 via the selected transaction network.

Additionally, during the processing and/or routing of the transaction, transaction-related information, information associated with the selected transaction network, and/or fee information associated with the routing may be collected by the service provider computer 105. In certain embodiments, such as embodiments in which the service provider computer 105 selects a transaction network, transaction-related information may be collected and stored in real-time during the evaluation of the transaction. In other embodiments, transaction-related information may be received in real-time or near real-time from another entity that evaluates a transaction and selects a transaction network.

A wide variety of transaction networks 175A-N may be utilized as desired. In certain embodiments, a transaction network may be a suitable PIN network or other network that allows a debit transaction to be routed. Examples of suitable PIN networks include, but are not limited to, the AFFN network, the STAR network, the PULSE network, the PLUS network, the Interlink network, and/or other networks. In certain embodiments, a PIN network may be an inter-bank network or a network that facilitates communications between financial institutions. Additionally, a PIN network may be different from a signature network (e.g., a VISA network, a MasterCard network, etc.) that facilitates the routing of credit transactions.

With continued reference to FIG. 1, any number of acquirer platforms 165 may be included in the system 100. An acquirer platform 165 may be a suitable system that receives, processes, and directs the routing of transactions on behalf of one or more merchants. Additionally, any number of financial institution and/or issuer systems 170 may be provided. A financial institution system 170 may facilitate the backend processing of a proposed transaction. For example, a financial institution system 170 may facilitate the approval and/or settlement of a proposed transaction. In certain embodiments, an acquirer platform 165 and/or a financial institution system 170 may include similar components as those discussed above for the service provider computer 105. For example, an acquirer platform 165 or a financial institution system 170 may include any number of processors, memories, I/O interfaces, and/or network/communication interfaces.

The system 100 shown in and described with respect to FIG. 1 is provided by way of example only. Numerous other operating environments, system architectures, and device configurations are possible. Other system embodiments can include fewer or greater numbers of components and may incorporate some or all of the functionality described with respect to the system components shown in FIG. 1. Accordingly, embodiments of the invention should not be construed as being limited to any particular operating environment, system architecture, or device configuration.

Operational Overview

FIG. 2 illustrates a flow diagram of an example process 200 for generating one or more presentations associated with the evaluation and/or optimization of transaction routing on behalf of a merchant. In certain embodiments, the operations of the method 200 may be performed by a suitable service provider computer and/or associated applications, such as the service provider computer 105, the dashboard modules 156, and/or the optimization modules 158 illustrated in FIG. 1. The method 200 may begin at block 205.

At block 205, information associated with any number of transactions submitted by a merchant or on behalf of a merchant may be identified. For example, historical information associated with submitted debit transaction may be identified, accessed, and/or obtained from any number of data sources. In certain embodiments, information may be identified for a predetermined historical period of time, such as the previous month, etc. As desired, information may also be identified in accordance with any number of other metrics (e.g., geographical area, merchant POS devices, merchant locations, etc.).

At block 210, at least a portion of the identified historical transaction information may be evaluated and/or processed. For example, the historical transaction information may be sorted and/or organized in accordance with any number of parameters, including but not limited to, transaction networks (e.g., a debit network or PIN network, etc.) utilized to route the transactions, various fees (e.g., network switch fees, network assessment fees, issuer interchange fees, issuer fraud recovery fees, issuer ad valorem fees, acquire transaction fees, etc.), transaction types (e.g., regulated or unregulated transaction, etc.), merchant point of sale locations, transaction amounts, transaction volumes, banking identification numbers (“BINs”), etc. Additionally, a wide variety of statistics and/or values associated with the historical transaction information (e.g., percentages of transactions attributable to each network, total fees incurred for various networks, average fees incurred for various networks, etc.). In certain embodiments, special arrangements and/or discounts associated with transaction networks may also be identified. For example, special arrangement and/or discount information may be received from a merchant or other data source. As another example, transaction fees, transaction volume, and/or transaction amount information may be evaluated in order to identify thresholds and/or situations at which discounts apply. As yet another example, incurred fees for a merchant may be compared to published fees associated with a transaction network in order to identify or determine discounts and/or special arrangements for the merchants. In certain embodiments, identified discounts and/or arrangements may be applicable for certain geographical areas and/or groups of merchant POS devices.

At block 215, at least one dashboard presentation may be generated and output for presentation to a merchant (or user associated with the merchant). In this regard, a wide variety of statistical information may be presented. For example, a merchant may be presented with information associated with percentages (and/or numbers) of transactions that are routed via various networks, sales volumes attributable to various networks, and/or fees incurred utilizing the various networks.

Additionally, as desired, a merchant may provide a wide variety of input that is processed in order to re-sort data, present data, and/or estimate or predict transaction routing data. In this regard, a merchant can review information associated with previously routed transactions. At block 220, a determination may be made as to whether user input associated with a dashboard presentation has been received. If it is determined at block 220 that no user input has been received, then operations may continue at block 235 described in greater detail below. If, however, it is determined at block 220 that user input has been received, then operations may continue at block 225.

At block 225, the received user input may be evaluated and/or otherwise processed. As desired, the historical transaction information may be reevaluated based at least in part upon the received user input. One or more updated presentations may then be generated for presentation at block 230. A wide variety of different types of user input may be received and processed as desired in various embodiments. For example, a merchant may provide input that facilitates the re-sorting and/or rearrangement of historical transaction information along any number of desired metrics (e.g., various fees, network transaction volume, etc.).

As another example, a merchant or other user may alter the amounts or values of a wide variety of variable information associated with the historical transaction information, such as various fees incurred as the result of utilizing various transaction networks. In this regard, a merchant may model different transaction routing scenarios in order to determine desired routing arrangements. For example, a merchant may evaluate fees for various transaction networks and/or network hierarchies. As another example, a merchant may evaluate proposed fee arrangements offered by issuers, acquirers, and/or other entities associated with the transaction networks. As another example, a merchant may assess the value of existing routing and/or transaction processing arrangements and/or discounts. As yet another example, a merchant may determine relatively advantageous network fees in order to facilitate negotiation and/or renegotiation of agreements. Indeed, a merchant may manipulate the historical transaction data for a wide variety of suitable business purposes. Following the generation of one or more updated presentations, operations may continue at either block 235 or block 220.

At block 235, which may be reached from either block 230 or block 220, a determination may be made as to whether an optimization of transaction routing networks has been enabled. For example, a determination may be made as to whether a user has requested an optimization or whether an automatic optimization has been enabled. If it is determined at block 235 that optimization has not been enabled, then operations may end. Otherwise, if it is determined at block 235 that optimization has been enabled, then operations may continue at block 240.

At block 270, a transaction network order may be optimized for subsequent transaction submission by the merchant. As desired, at least a portion of the historical transaction information may also be evaluated in order to determine an optimal order for selecting transaction networks in order to route transactions. For example, historical transaction information may be provided to one or more models that determine an optimal transaction network order for a merchant. As desired, a wide variety of other information may also be provided to a model, such as information associated with special arrangements and/or deals for a merchant in association with various transaction networks (e.g., arrangement information received from merchants, arrangement information derived or determined from comparing historical transaction information with standard rate information and/or transaction information for other merchants, etc.), merchant preferences for network selections, etc. Based at least in part upon the modeling and/or analysis, an ordering of transaction networks (i.e., a hierarchy for selecting transaction networks for routing, etc.) may be optimized for the merchant along any number of parameters. For example, an ordering may be optimized in order to minimize fees paid by the merchant. Additionally, as desired, any number of routing tables may be generated in association with the optimized ordering, and the routing tables may be provided to the merchant and/or to merchant POS devices. The method 200 may end following either block 235 or block 240.

FIG. 3 illustrates a flow diagram of an example process 300 for determining an optimized network order for routing transactions on behalf of a merchant. In certain embodiments, the operations of the method 300 may be performed by a suitable service provider computer and/or associated applications, such as the service provider computer 105, the dashboard modules 156, and/or the optimization modules 158 illustrated in FIG. 1. The method 300 may begin at block 305.

At block 305, information associated with any number of transactions submitted by a merchant or on behalf of a merchant may be identified. For example, historical information associated with submitted debit transaction may be identified, accessed, and/or obtained from any number of data sources. At block 310, the transactions may be sorted by transaction network. Additionally, at block 315, a wide variety of fees associated with each of the networks and/or transactions may be identified and/or determined. As desired, fee information may be evaluated in order to identify any special discounts or arrangements that a merchant has for utilizing various networks. In certain embodiments, available networks that were not utilized in the historical transactions and fees associated with the available networks may also be identified.

At block 320, a wide variety of merchant parameters and/or preferences may be identified. For example, special arrangements and/or discounts that a merchant has with various networks (e.g., an arrangement in which a certain number of transactions will be routed via a particular network in order to obtain a discounted rate, etc.). As another example, merchant preferences associated with a network hierarchy may be identified. As yet another example, merchant preferences associated with regulated and/or unregulated networks may be identified.

At block 325, an optimum network order or routing scheme may be determined based upon an evaluation of the historical information and/or other data (e.g., data associated with unused networks, data associated with established arrangements and/or relationships, etc.). As desired, a network order may be determined in accordance with any number of criteria. For example, an order for selecting available networks may be determined in order to minimize routing fees paid by the merchant. As desired, a determined order may be optimized in order to satisfy parameters and/or conditions associated with contracts or arrangements that the merchant has with various routing entities.

At block 330, one or more routing tables may be generated based upon the optimized network order. For example, a routing table that includes a hierarchy of BIN numbers associated with the optimized network order may be generated. As desired, the generated routing tables may be provided to a merchant and/or distributed to any number of other devices, such as merchant POS devices, acquiring platforms, and/or service providers of the merchant. The method 300 may end following block 330.

The operations described and shown in the methods 200 and 300 of FIGS. 2-3 may be carried out or performed in any suitable order as desired in various embodiments of the invention. Additionally, in certain embodiments, at least a portion of the operations may be carried out in parallel. Furthermore, in certain embodiments, less than or more than the operations described in FIGS. 2-3 may be performed.

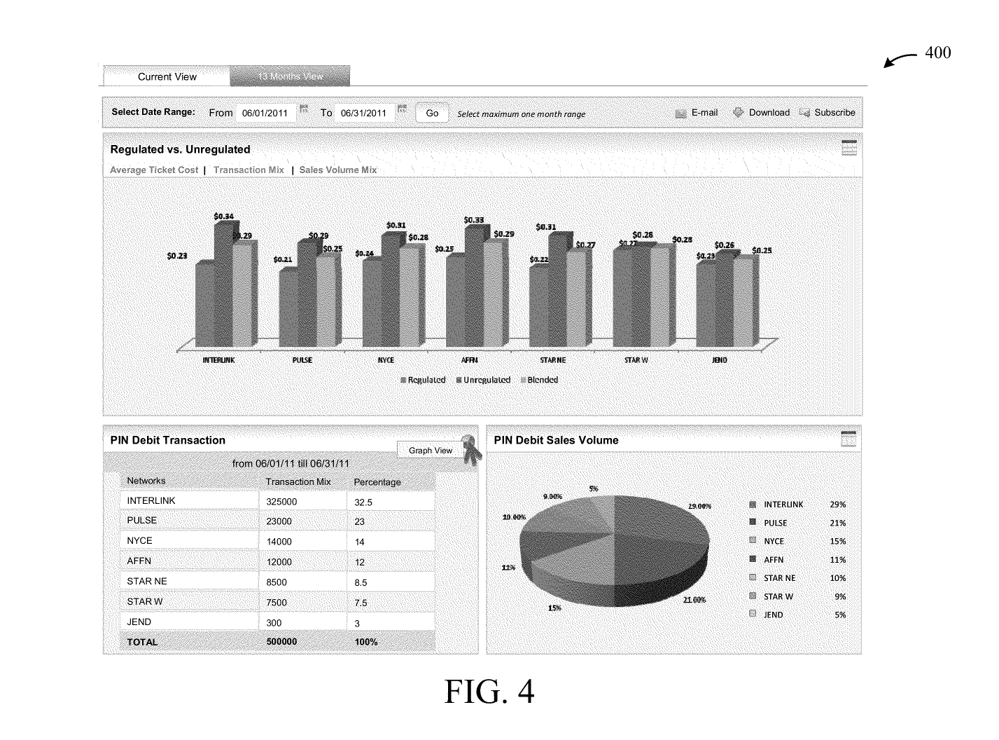

FIGS. 4-8 illustrate example graphical user interfaces that may be generated in accordance with various embodiments of the disclosure for presentation to merchants or other customers of a service provider. FIG. 4 illustrates an example dashboard presentation 400 in which statistical information associated with historical transactions is illustrated. The dashboard presentation 400 illustrates a number and percentage of transactions that were routed via each of a plurality of transaction networks, as well as sales volume attributable to each network. Additionally, a wide variety of other statistics can be presented as desired (e.g., as selected by a user. For example, as shown in the dashboard presentation 400, the average routing or ticket cost(s) for each of the transaction networks is illustrated. As desired, cost may be apportioned to regulated (e.g., payment accounts issued by a financial institution with greater than $10 billion in assets) and unregulated transactions. The fees for regulated transactions may be capped in accordance with legal requirements. Additionally, blended fee information derived from the regulated and unregulated transactions may be illustrated.

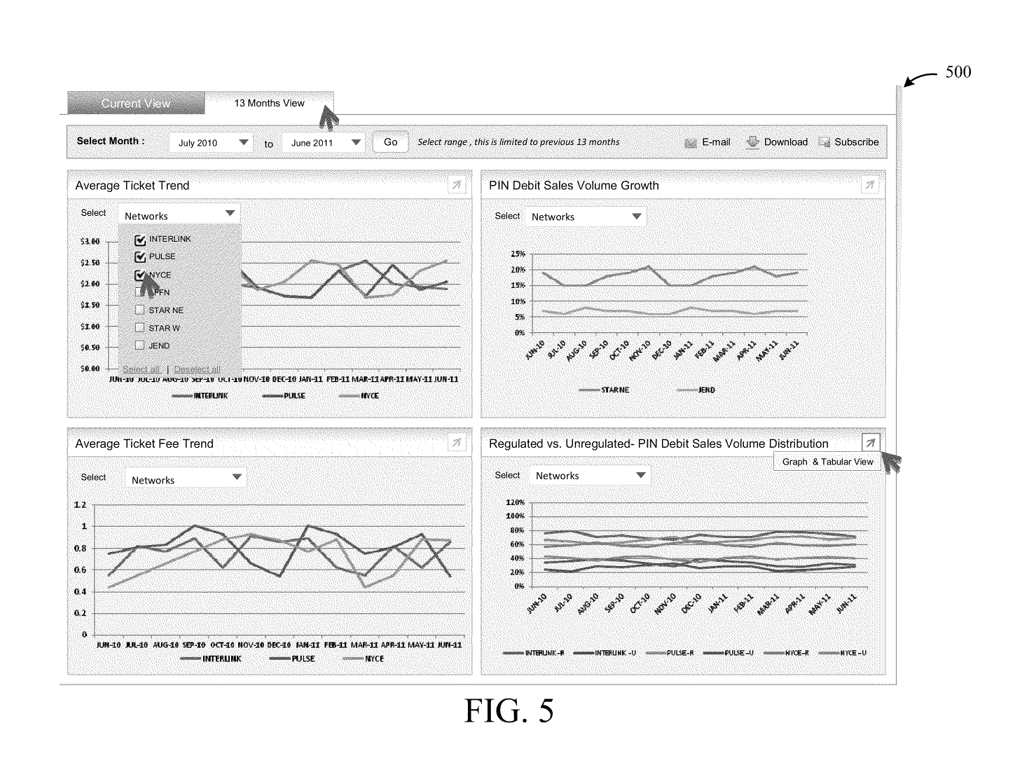

FIG. 5 illustrates additionally example dashboard presentation 500 that may be presented. As desired, a user may request any number of graphs and/or charts that facilitate the evaluation and/or analysis of transaction network usage and/or fees. Additionally, various trends may be graphed. As shown in FIG. 5, the average number of transactions routed via any number of networks (e.g., networks selected by a user, all networks utilized by a merchant, etc.) may be plotted or illustrated over time. As another example, the average cost or incurred fees for transactions routed via any number of networks. As yet another example, the growth of transactions routed via any number of networks may be illustrated aver time. As yet another example, the distribution of regulated and unregulated transactions for various financial networks may be illustrated over time.

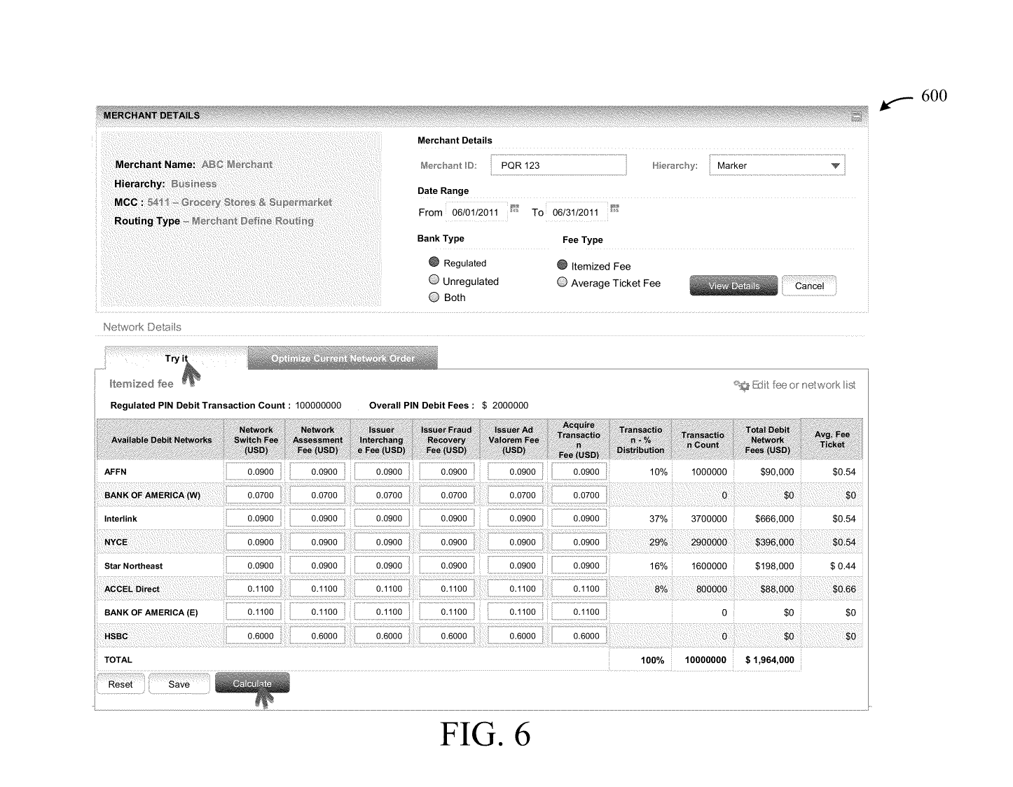

FIG. 6 illustrates an example dashboard presentation 600 that sets forth fee information for payment transactions. A wide variety of different fees (e.g., average fees, etc.) may be illustrated for each of a plurality of transaction networks, such as a network switch fee, a network assessment fee, an issuer interchange fee, an issuer fraud recovery fee, an issuer ad valorem fee, and/or an acquire transaction fee. As desired, other information may also be illustrated, such as a transaction count for each network, distribution information for the various networks, and/or a total number of fees associated with each network. Additionally, in certain embodiments, information may be sorted based upon a wide variety of different metrics and/or parameters (e.g., regulated and/or unregulated, fee type, etc.).

As desired, a user may manipulate a wide variety of variable information included in the presentation 600 of FIG. 6. For example, the amount of a fee and/or a distribution of transactions among networks may be manipulated. Additionally, calculated information, such as a calculated total fee amount, may be updated based at least in part upon the user manipulation. In this regard, the user may model a wide variety of conditions, such as changes to their transaction network hierarchy.

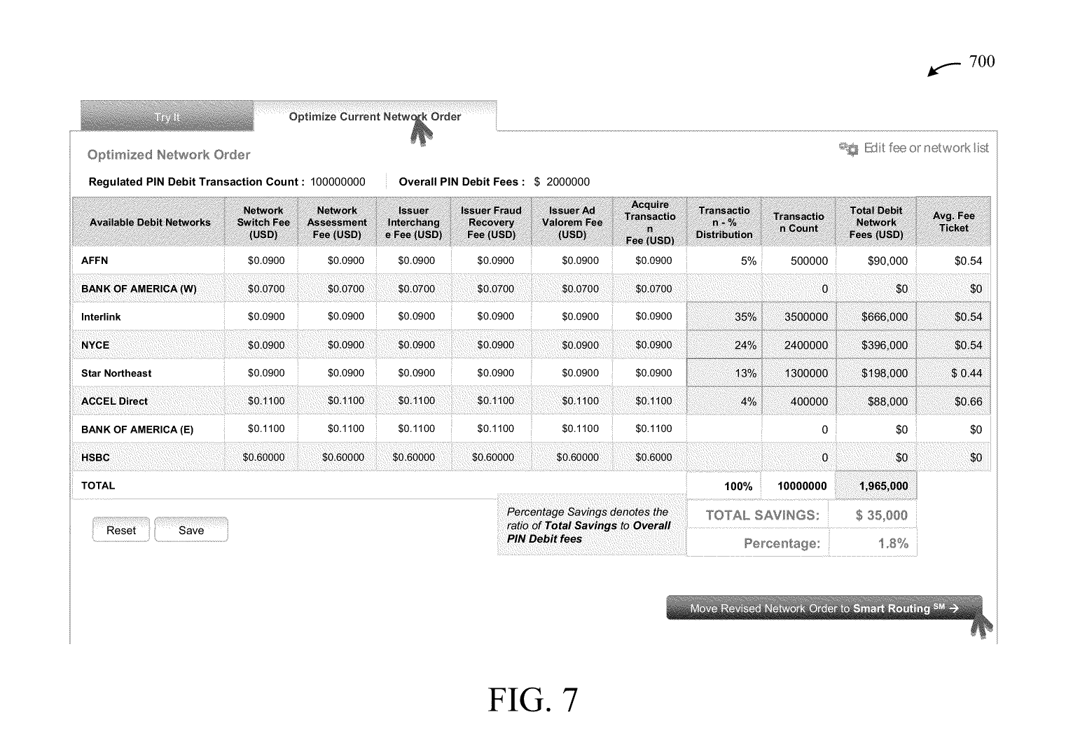

FIG. 7 illustrates an example dashboard presentation 700 in which a user has requested an optimization of a transaction network order or hierarchy. Based upon an evaluation of historical transaction data and/or fees associated with networks (as well as a wide variety of other information), a desired order of networks may be identified, and a distribution of the transactions among the networks may be determined. Additionally, a cost savings associated with the determined order of networks may be calculated for the merchant. The dashboard presentation may contain other interactive display modules such as selectable links, buttons, etc., configured to transmit user preferences to the service provider. In the embodiment shown in FIG. 7, at least one selectable link or button can be implemented to transmit one or more user selected inputs or preferences.

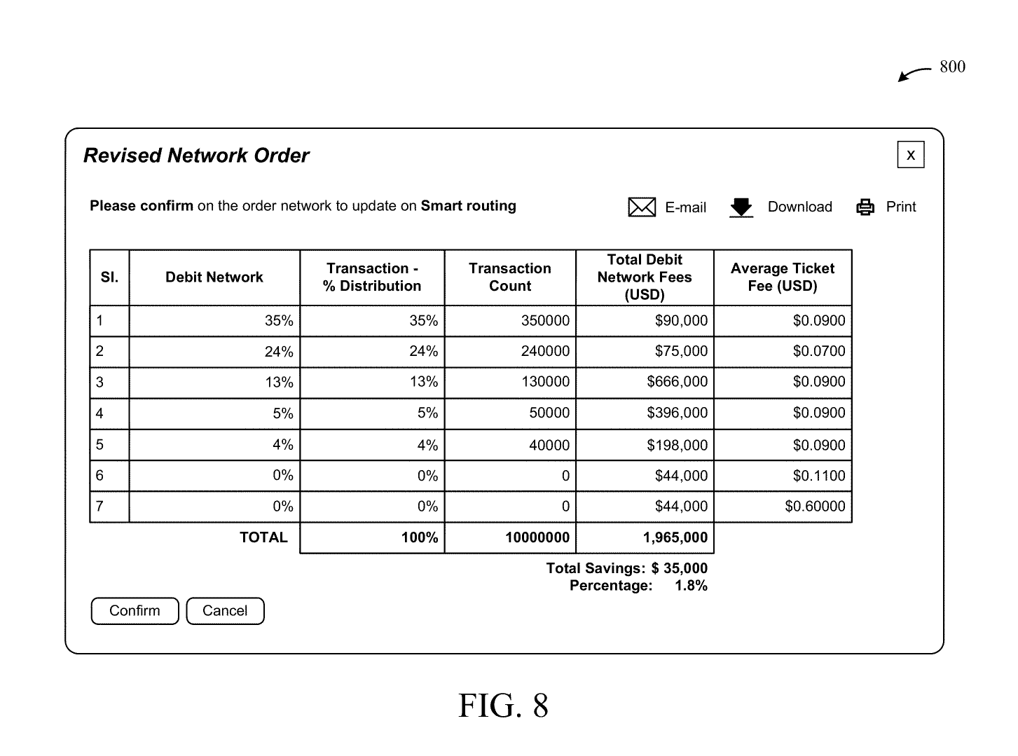

FIG. 8 illustrates an example presentation 800 that includes an optimized network order or hierarchy. The network order may be determined based upon an evaluation of historical transaction and/or other information. Additionally, as illustrated in FIG. 7, likely cost savings information associated with the network order may be illustrated in FIG. 8. In the event that a user confirms an optimized network order, a routing table associated with the optimized network order may be generated for use in routing subsequent transactions.

The graphical user interfaces illustrated in FIGS. 4-8 are just a few of the example interfaces that may be generated in accordance with various embodiments of the disclosure. A wide variety of other types of graphical user interfaces may be generated as desired. Additionally, a generated interface may include a wide variety of different information formatted and/or organized utilizing a wide variety of different techniques and/or layouts.

The invention is described above with reference to block and flow diagrams of systems, methods, apparatuses, and/or computer program products according to example embodiments of the invention. It will be understood that one or more blocks of the block diagrams and flow diagrams, and combinations of blocks in the block diagrams and the flow diagrams, respectively, can be implemented by computer-executable program instructions. Likewise, some blocks of the block diagrams and flow diagrams may not necessarily need to be performed in the order presented, or may not necessarily need to be performed at all, according to some embodiments of the invention.

Various block and/or flow diagrams of systems, methods, apparatus, and/or computer program products according to example embodiments of the invention are described above. It will be understood that one or more blocks of the block diagrams and flow diagrams, and combinations of blocks in the block diagrams and flow diagrams, respectively, can be implemented by computer-executable program instructions. Likewise, some blocks of the block diagrams and flow diagrams may not necessarily need to be performed in the order presented, or may not necessarily need to be performed at all, according to some embodiments of the invention.

These computer-executable program instructions may be loaded onto a special purpose computer or other particular machine, a processor, or other programmable data processing apparatus to produce a particular machine, such that the instructions that execute on the computer, processor, or other programmable data processing apparatus create means for implementing one or more functions specified in the flow diagram block or blocks. These computer program instructions may also be stored in a computer-readable memory that can direct a computer or other programmable data processing apparatus to function in a particular manner, such that the instructions stored in the computer-readable memory produce an article of manufacture including instruction means that implement one or more functions specified in the flow diagram block or blocks. As an example, embodiments of the invention may provide for a computer program product, comprising a computer-usable medium having a computer-readable program code or program instructions embodied therein, said computer-readable program code adapted to be executed to implement one or more functions specified in the flow diagram block or blocks. The computer program instructions may also be loaded onto a computer or other programmable data processing apparatus to cause a series of operational elements or steps to be performed on the computer or other programmable apparatus to produce a computer-implemented process such that the instructions that execute on the computer or other programmable apparatus provide elements or steps for implementing the functions specified in the flow diagram block or blocks.

Accordingly, blocks of the block diagrams and flow diagrams support combinations of means for performing the specified functions, combinations of elements or steps for performing the specified functions and program instruction means for performing the specified functions. It will also be understood that each block of the block diagrams and flow diagrams, and combinations of blocks in the block diagrams and flow diagrams, can be implemented by special purpose, hardware-based computer systems that perform the specified functions, elements or steps, or combinations of special purpose hardware and computer instructions.

Many modifications and other embodiments of the invention set forth herein will be apparent having the benefit of the teachings presented in the foregoing descriptions and the associated drawings. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation.

The claimed invention is:

1. A method, comprising:
obtaining, by a service provider system comprising one or more computers, information associated with a plurality of payment transactions processed via a plurality of transaction networks;
generating, by the service provider system based at least in part upon the information, one or more graphical user interfaces associated with the distribution of payment transactions among the plurality of transaction networks;
receiving, by the service provider system via the one or more graphical user interfaces, user input associated with the distribution of payment transactions; and
generating, by the service provider system based upon the received user input, one of a recommendation or updated distribution information.

2. The method of claim 1, wherein obtaining information associated with a plurality of payment transaction comprises storing information as payment transactions are communicated from one or more merchant devices to one or more transaction processing system.

3. The method of claim 1, wherein receiving user input comprises receiving user input associated with the modification of a transaction network fee.

4. The method of claim 1, further comprising identifying a plurality of preferences received from one or more merchant devices.

5. The method of claim 1, wherein receiving user input comprises:
receiving a request to optimize an order of transaction networks; and
wherein generating one or a recommendation of updated distribution information comprises generating an optimized order of transaction networks.

6. The method of claim 5, further comprising generating a routing table associated with the optimized order of transaction networks.

7. A system comprising:
a service provider server, having one or more computers, wherein each computer is configured with a communication connection, wherein the service provider server is configured to:
obtain information associated with a plurality of payment transactions processed via a plurality of transaction networks;
generate one or more graphical user interfaces associated with the distribution of payment transactions among the plurality of transaction network, based at least in part on the information;
receive, via the one or more graphical user interfaces, user input associated with the distribution of payment transactions; and
generate based upon the received user input one of a recommended or updated distribution information.

8. The system of claim 7, wherein to obtain information associated with a plurality of payment transaction comprises storing information as payment transactions are communicated with one or more merchant devices to one or more transaction processing system.

9. The system of claim 7, wherein to receive user input further comprises receiving user input associated with the modification of a transaction network fee.

10. The system of claim 7, wherein the service provider server is further configured to:
retrieve from a user device, a plurality of preferences associated with a transaction network.

11. The system of claim 7, wherein to receive user input further comprises receiving a request to optimize an order of transaction networks wherein generating one or a recommendation of updated distribution information comprises generating an optimized order of transaction networks.

12. The system of claim 11, wherein the service provider server is further configured to:
generate a routing table associated with the optimized order of transaction networks.

13. The system of claim 7, wherein the service provider server is further configured to:
output to display a human machine interface (HMI) including a dashboard presentation, wherein the dashboard presentation represents an optimized network order.

14. The system of claim 13, wherein the dashboard presentation further comprises at least one input configured to retrieve user preferences.

15. One or more computer-readable media storing computer-executable instructions that, when executed by at least one processor, configure the at least one processor to perform operations comprising:
obtaining, by a service provider system comprising one or more computers, information associated with a plurality of payment transactions processed via a plurality of transaction networks;
generating, by the service provider system based at least in part upon the information, one or more graphical user interfaces associated with the distribution of payment transactions among the plurality of transaction networks;
receiving, by the service provider system via the one or more graphical user interfaces, user input associated with the distribution of payment transactions; and
generating, by the service provider system based upon the received user input, one of a recommendation or updated distribution information.

16. The one or more computer-readable media of claim 15, wherein the operation of obtaining information associated with a plurality of payment transaction comprises storing information as payment transactions are communicated from one or more merchant devices to one or more transaction processing system.

17. The one or more computer-readable media of claim 15, wherein the operation of receiving user input comprises receiving user input associated with the modification of a transaction network fee.

18. The one or more computer-readable media of claim 15, wherein the at least one processor performs operations further comprising:
identifying a plurality of preferences received from one or more merchant devices.

19. The one or more computer-readable media of claim 15, wherein the operation receiving user input comprises receiving a request to optimize an order of transaction networks, and
wherein generating one or a recommendation of updated distribution information comprises generating an optimized order of transaction networks.

20. The one or more computer-readable media of claim 19, wherein the at least one processor performs operations further comprise generating a routing table associated with the optimized order of transaction networks.
